(19) United States
(12) Patent Application Publication
(10) Pub. No.: US 2009/0256279 A1
(43) Pub. Date: Oct. 15, 2009

(54) MOLD FOR PREPARATION OF RECIPIENT BLOCK AND PREPARATION METHOD OF RECIPIENT BLOCK USING THE SAME

(76) Inventors: Young Do Lee, Seoul (KR); Hyeong Jae Jeong, Seoul (KR)

Correspondence Address: SHERIDAN ROSS PC, 1560 BROADWAY, SUITE 1200, DENVER, CO, 80202, US

(21) Appl. No.: 12/295,927

(22) PCT Filed: Apr. 10, 2006
(86) PCT No.: PCT/KR06/01298

§ 371 Date: Oct. 3, 2008

(30) Foreign Application Priority Data
Apr. 5, 2006 (KR) 10-2006-0030943

(51) Int. Cl. B29C 33/40; B28B 7/30; B29C 35/16

(52) U.S. Cl. 264/225; 425/447; 264/313

(57) ABSTRACT

Disclosed is a mold for the preparation of recipient blocks, made from silicone, and a method of constructing a mold for the preparation of recipient blocks, comprising: charging a structure equipped with a mold in the form of a recipient block with silicone; curing the silicone; and separating the silicone mold for the preparation of recipient block from the structure. Also, a method is provided for preparing a recipient block, comprising: positioning the mold for the preparation of recipient blocks within a base mold; charging the base mold with a liquid material for the recipient block; solidifying the material and separating the base mold from the mold for the preparation of recipient blocks and the solidified material; and separating the mold for the preparation of recipient blocks from the solidified recipient block.

### TECHNICAL FIELD

The present invention relates to a mold for the preparation of recipient blocks and to a method for preparing recipient blocks using the same. More particularly, the present invention relates to a silicone mold for the preparation of recipient blocks, which is stable and undeformable at high temperature and highly flexible, and a method for preparing a recipient block using the same.

### BACKGROUND ART

Tissue microarrays are produced by relocating tissue from conventional histologic paraffin blocks such that many pieces of tissue (typically about 30˜120 pieces of tissue) can be seen on the same glass slide (about 2.5×7.5 cm in size). Human or animal tissues and cells are typical targets, and are assembled in an array to allow simultaneous histological analysis, such as protein, DNA and/or RNA analysis, under microscopes. Tissue microarray slides can be used for most tissue analysis techniques (e.g., in situ PCR, Special stain, in situ hybridization, Immunohistochemistry, etc.).

In a classical method of tissue analysis, only one tissue sample (1×2×0.4 cm or larger) is attached to one glass slide. This classical method not only uses as many glass slides as the number of tissue samples to be analyzed, but also requires reagents and supplies in large quantities. Accordingly, a lot of time, expense and labor are needed for analyzing tissues through the classical method. Moreover, because the classical method separately and individually treats the tissue samples which are to be subjected to comparative analysis, the analysis is not consistent throughout, resulting in a decrease in the reliability of the analysis data thus obtained.

In the tissue microarray technique, tissue cores are removed from regions of interest in paraffin embedded tissues, such as clinical biopsies or tumor samples, and then inserted in a recipient block in a precisely spaced array pattern. Sections from this block are cut using a microtome, mounted on a glass slide, and then analyzed using any standard histological analysis method. Tissue microarray techniques are described in the following patents.

International Patent PCT/DE00/04647 discloses a method for the production of a recipient block capable of accommodating a plurality of tissue samples. In the method, an aluminum block in a tray form is bored at the lower end thereof and the openings thus formed have cylinder pins inserted therein to produce a mold for a recipient block. Molten paraffin liquid is charged into the mold and then cooled to solidification to produce a recipient block containing a number of openings for accommodating the corresponding tissue samples.

U.S. Pat. Publication No. 2005/0260740 discloses a tissue micro-array (TMA) building manual set, which includes a TMA block mold, made from iron, for preparing a recipient block. Molten paraffin is charged into the block mold and cooled to solidification, and the mold is covered with a cassette. The recipient block thus formed is separated from the mold by being slowly lifted upwards by means of threaded arms provided on both sides of the mold.

However, when separated from the metal molds disclosed in the above-mentioned patent references, the solidified paraffin recipient blocks with openings formed therein, are apt to break due to friction between the recipient blocks and the molds. Moreover, this shortcoming makes it difficult to provide recipient blocks having openings of various sizes (0.6 mm, 1.0 mm, 2.0 mm, 3.0 mm, 5.0 mm), which are typically required for tissue microarrays. Particularly, the tissue micro-array (TMA) building manual set according to U.S. Pat. Publication No. 2005/0260740 cannot be used to construct openings of various sizes, and, in addition, is expensive.

Other typical methods for preparing recipient blocks are exemplified by the use of a punching machine or a drill to form cylindrical openings of desired sizes in paraffin blocks. Even with these methods, the rigid paraffin recipient blocks are likely to break during the formation of openings, and it is difficult to locate the openings at regular intervals and arrays. Further, a great quantity of time and labor are required, because all of the cylindrical openings must be individually constructed with these conventional methods.

Furthermore, invisible fine cracks may form in the recipient blocks prepared through conventional methods. In this case, when the recipient blocks, in which tissue samples are arrayed, are sectioned, the sections are highly liable to divide into pieces.

### DISCLOSURE OF THE INVENTION

Leading to the present invention, intensive and thorough research on a simple method for preparing a recipient block without generating any cracks therein, conducted by the present inventor, resulted in the finding that a mold made from silicone which is thermally stable and undeformable at high temperatures and highly flexible can be used to prepare recipient blocks without generating cracks therein.

In accordance with an aspect thereof, the present invention provides a mold for the preparation of recipient blocks, which is made from silicone.

In accordance with another aspect thereof, the present invention provides a method for constructing a mold for the preparation of recipient blocks, comprising: (1) charging a structure equipped with a mold in the form of a recipient block with silicone; (2) curing the silicone; and (3) separating the silicone mold for the preparation of recipient blocks from the structure.

In accordance with a further aspect thereof, the present invention provides a method for preparing a recipient block, comprising: (1) positioning the mold for the preparation of recipient blocks within a base mold; (2) charging the base mold with a liquid material (e.g., paraffin) for the recipient block; (3) solidifying the material (e.g., paraffin) and separating the base mold from the mold for the preparation of recipient blocks and the solidified material; and (4) separating the mold for the preparation of recipient blocks from the solidified recipient block.

### BRIEF DESCRIPTION OF THE DRAWINGS

FIG. 1 shows a recipient block.

FIG. 2 shows a mold for the preparation of a recipient block.

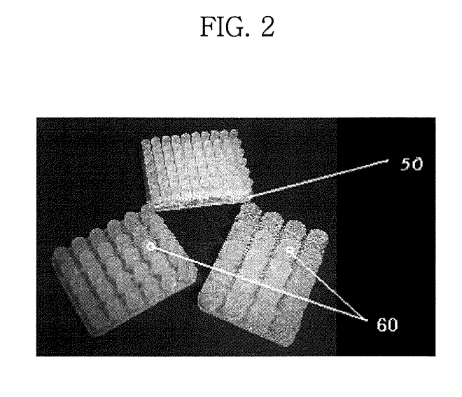

FIG. 3A shows photographs after the mold for the preparation of a recipient block in accordance with the present invention is positioned within a base mold (left) and after molten paraffin is poured over the mold and covered with a cassette (right).

FIG. 3B shows photographs after the paraffin is solidified and the base mold is separated (left) and after the mold for the preparation of a recipient block is removed from the paraffin molded into a recipient block (right).

FIG. 3C shows a recipient block completely separated from the mold for the preparation of recipient blocks.

### DESCRIPTION OF NUMERALS FOR MAIN PARTS

20: Recipient block

21: Opening

30: Base mold

40: Cassette

50: Mold for the preparation of recipient blocks

60: Cylindrical projections

### BEST MODE FOR CARRYING OUT THE INVENTION

The present invention pertains to a mold for the preparation of recipient blocks and to a method of preparing recipient blocks using the same. First, a description will be given of a recipient block and various tools for use in preparing the recipient block, including the mold for the preparation of recipient blocks in accordance with the present invention.

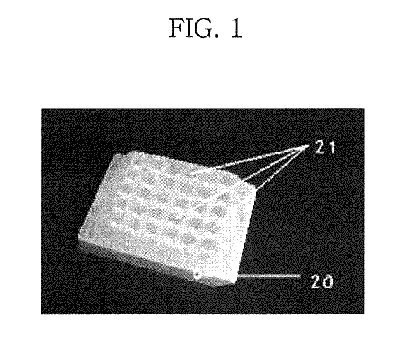

The term “recipient block 20”, as used herein, is intended to refer to a tool serving as a mandrel for locating corresponding tissue samples at predetermined positions on tissue microarray slides (FIG. 1). The recipient block has a plurality of cylindrical openings 21 for accommodating tissue samples, and is rigid but fragile because it is made mainly from paraffin.

The term “base mold 30”, as used herein, is intended to refer to a tool for use in determining the contour of the recipient block. The base mold is typically made from metal, and has a frame in a block shape (the shape of a recipient block lacking cylindrical openings, e.g., a rectangular parallelepiped). The size of the recipient block is dependent on that of the base mold frame. Hence, it is important to select a base mold that is suitable in size for the recipient block. The first thing to do when preparing a recipient block is to position a mold for the preparation of recipient blocks, which will be described later, within the frame of the base mold.

As used herein, the term “mold 50 for the preparation of recipient blocks” is intended to refer to a tool having a structure corresponding to a desired recipient block, that is, a tool for molding a recipient block. The mold 50 for the preparation of recipient blocks is provided with a plurality of cylindrical projections 60, which serve to form cylindrical openings in the recipient blocks. Thus, the diameter of the cylindrical projections 60 determines the size of the cylindrical openings in the recipient block. That is, the preparation of a recipient block having a predetermined size of openings requires a mold provided with projections having a corresponding size. The mold for the preparation of recipient blocks in accordance with the present invention is made from highly resilient silicone, which is stable and unchangeable at high temperatures.

The term “cassette 40”, as used herein, is intended to refer to a tool which serves as a holder for supporting the recipient block when the solidified recipient block is lifted. That is, after molten paraffin (the material for recipient blocks) is charged into the base mold frame, the frame is covered with the cassette 40. While solidifying, the paraffin becomes firmly attached to the cassette. Accordingly, the recipient block can be easily separated from the base mold simply by lifting the cassette. At this time, the recipient block may remain attached to the cassette. Nonetheless, the flexibility of the mold according to the present invention allows the recipient block to be separated therefrom easily. If the mold for the preparation of recipient blocks is pulled with one hand while the cassette is held in the other hand, the recipient block is readily separated from the mold.

In accordance with the present invention, the mold for the preparation of recipient blocks is made from silicone.

Generally, silicones are inorganic-organic polymers consisting of an inorganic silicon-oxygen backbone (—Si—O—Si—) with organic side groups attached to the silicon atoms. Silicones have many desirable properties, including non-toxicity, thermal stability, freezing resistance, weather resistance, chemical resistance, hot-water resistance, electrical insulation, radiation resistance, oil resistance, pigmentation, transparency, elasticity, and recovery power. The mold for the preparation of recipient blocks in accordance with the present invention retains the above properties of silicones.

In a preferable embodiment, the mold for the preparation of recipient blocks in accordance with the present invention is made from silicone rubber. Depending on the degree of polymerization of the material polymer, silicon rubber is classified into millable rubber and liquid silicone rubber. Both of them are useful in the preparation of the mold according to the present invention.

In the case of using millable rubber, silicone polymer (raw rubber) is compounded with silica-based reinforcing fillers and various additives to afford a base compound, which is then heat cured in the presence of a curing agent to form a mold for the preparation of recipient blocks. Examples of silicone rubber useful in the present invention include dimethyl silicone rubber, methyl phenyl silicone rubber, methyl vinyl silicone rubber and fluoride silicone rubber. Fumed silica or precipitated silica can be used as a silica-based reinforcing filler for increasing the strength of the mold. Organic peroxide is typically used as a curing agent. The kind of curing agent determines the method and temperature of molding. Upon molding, for example, the base compound is cured with 2,5-dimethyl-2,5-bis(t-butylperoxy)hexane at about 170° C. for 10 min. Upon extrusion, curing is conducted at about 110° C. for 5 min in the presence of bis(2,4-dichlorobenzoyl)peroxide.

As for liquid silicone rubber, a polymer thereof may be compounded with a crosslinking agent, a curing catalyst, a filler, and additives. The type of the liquid silicone rubber determines the available polymers and additives. That is, the kinds of polymers, crosslinking agents, curing catalysts and fillers useful in the present invention may vary depending on whether the liquid silicone rubber is a condensed type, an additive type, a single-component type, or a multi-component type. Available polymers include dihydroxy-polydiethyl-poly-siloxane and divinyl-poly-dimethyl-poly-siloxane. An SiH compound can be used as a crosslinking agent. Examples of the curing catalyst useful in the present invention include organic tin compounds, organic titanium compounds and platinum compounds. As a filler, fumed silica, quartz powder, calcium carbonate, precipitated silica or diatomite may be used. Optionally, additives, such as an adhesion enhancer, a preservative, and a curing controller, may be employed. In this regard, products produced from suitable combinations of polymers, crosslinking agents, curing catalysts, fillers, etc. are commercially available. These commercially available products can be employed in the present invention. Although it is curable rubber, liquid silicone rubber can be continuously supplied to an injection molding machine, thanks to the liquid property thereof, so that molds for the preparation of recipient blocks can be automatically produced. Particularly, the liquid silicone rubber is outstanding in electrical insulation and weather resistance, in addition to showing flexible properties and characteristic silicon properties over a wide temperature range, from −70 to 200° C. Hence, it is preferable to prepare the mold for the preparation of recipient blocks from liquid silicone rubber.

Conventional silicone molding methods, exemplified by silicone compression molding, injection molding, extrusion molding, calendar molding, coating molding and roll molding, can be applied to the preparation of the mold according to the present invention.

The mold for the preparation of recipient blocks in accordance with the present invention can be produced according to various methods, depending on the type of silicone and corresponding molding methods. In an embodiment of the present invention, the mold for the preparation of recipient blocks is prepared by a method comprising (1) charging silicone into a structure having a mold in the form of a recipient block; (2) curing the silicone; and (3) separating the silicone mold for the preparation of recipient blocks from the structure.

In step (1), silicone is charged into a structure having a mold in the form of a recipient block. This silicone is preferably liquid silicone rubber. The liquid silicone rubber may be a condensation type, an additive type, a single-component type, or a multi-component type. Preferably liquid silicone rubber is used, which is an additive and multi-component type. As described above, the structure preferably has a mold in the form of a recipient block.

In step (2), the charged silicone is cured. In this regard, a suitable curing method and time may be readily selected by those skilled in the art, depending on various factors including temperature, catalyst, radical, silicon type, etc. After the silicone is completely cured, the silicone mold for the preparation of recipient blocks is separated from the structure having a mold in the form of a recipient block.

In accordance with another embodiment thereof, the present invention provides a method for preparing a recipient block using the mold. The method comprises (1) locating a mold, made from silicone, for the recipient blocks within a base mold; (2) charging the base mold with a liquid material (paraffin) for the recipient block; (3) separating the base mold from the mold for the preparation of recipient blocks after the liquid material is solidified; and (4) separating the solidified material in the form of a recipient block from the mold for the preparation of recipient blocks.

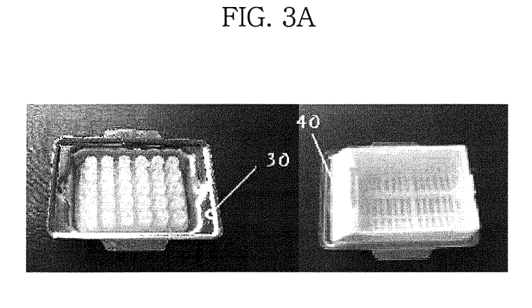

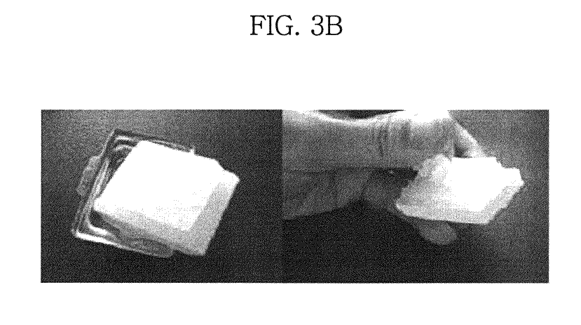

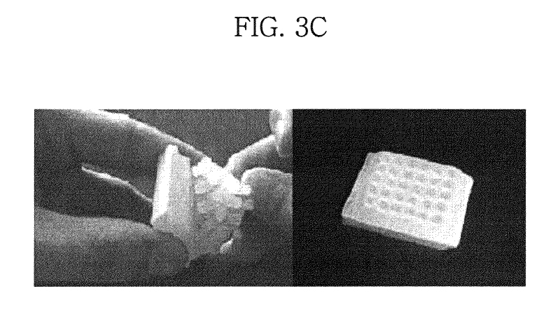

In step (1), the mold for the preparation of recipient blocks in accordance with the present invention is positioned in the frame of the base mold (FIG. 3A). Preferably, the mold for the preparation of recipient blocks is located in such a way that the projections provided for the mold are directed upward.

In step (2), the frame of the base mold is charged with a liquid material for recipient blocks. The liquid material is preferably molten paraffin. Also, a cassette is positioned on the upper end of the material in the frame of the base mold (FIG. 3B). As described above, the material for the recipient block is firmly attached onto the cassette during the solidification thereof, and the cassette serves as a holder useful in the preparation of recipient blocks as well as subsequent purposes (for example, application to a microtome).

In step (3), the base mold is taken off after the material has solidified (FIG. 3B). In order to reduce the time that it takes for the material to solidify, the material is preferably cooled. In the case where the cassette is used in step (2), the base mold can be readily separated simply by lifting the cassette. After the base mold is removed, the cassette still remains attached to the recipient block and the mold for the preparation of recipient blocks.

In step (4), the mold for the preparation of recipient blocks is removed from the resulting structure. Thanks to the flexibility thereof, the mold for the preparation of recipient blocks can be removed easily. For example, while the cassette is held in one hand, the mold can be pulled off with the other hand (FIG. 3C).

### EXAMPLES

### Example 1

### Construction of Mold for the Preparation of Recipient Blocks

A mold for the preparation of recipient blocks was constructed from liquid silicone rubber (LSR) using an injection molding system. In detail, a two-component type silicone (LSR2650) was automatically mixed at a predetermined ratio (1:1) using a pump dedicated thereto, charged into an injection molding structure in the form of a recipient block, and cured at 180° C. for 30 min, followed by removing the silicone mold from the molding machine. All of the molding processes, including silicone injection, mixing, and molding, were conducted under airtight conditions without the injection of materials other than silicone.

### Example 2

### Preparation of Recipient Block Using the Mold

The mold for the preparation of recipient blocks, constructed in Example 1, was positioned within the frame of the base mold in such a way that the projections of the mold are directed upwards (FIG. 3A, left). Subsequently, molten paraffin was poured over the mold in the frame of the base mold and covered with a cassette, followed by solidifying the paraffin on a cold plate for 3˜5 min (FIG. 3A, right). After the paraffin was completely solidified, the cassette was lifted upwards to separate the base mold from a conjugate of the solidified paraffin and the mold for the preparation of the recipient block (FIG. 3B, left). Afterwards, the mold for the preparation of the recipient blocks was removed from the recipient block thus formed (FIG. 3C, left). As a result, a desirable recipient block was obtained (FIG. 3C, right).

### INDUSTRIAL APPLICABILITY

As described hitherto, the mold for the preparation of recipient blocks in accordance with the present invention allows desirable recipient blocks to be prepared in a simple manner. In addition, when molded, the recipient blocks can be obtained without cracking or breaking, thanks to the flexibility of the mold. Furthermore, the tissue microarray blocks do not crack while being sectioned.

What is claimed is:

1. A mold for the preparation of recipient blocks, made from silicone.

2. The mold according to claim 1, wherein the silicone is silicone rubber.

3. A method of constructing a mold for the preparation of recipient blocks, comprising:
(1) charging a structure equipped with a mold in the form of a recipient block with silicone;
(2) curing the silicone; and
(3) separating the silicone mold for the preparation of recipient block from the structure.

4. The method according to claim 3, wherein the silicone is silicone rubber.

5. A method of preparing a recipient block, comprising:
(1) positioning the mold for the preparation of recipient blocks of claim 1 within a base mold;
(2) charging the base mold with a liquid material for the recipient block;
(3) solidifying the material and separating the base mold from the mold for the preparation of recipient blocks and the solidified material; and
(4) separating the mold for the preparation of recipient blocks from the solidified recipient block.

6. The method according to claim 5, wherein the liquid material for the recipient block includes paraffin.

7. The method according to claim 6, further including positioning a cassette on the material subsequent to charging the base mold with the liquid material for the recipient block.

8. The method according to claim 5, wherein the material is solidified in step (3) while being cooled.

9. A method of preparing a recipient block, comprising:
(1) positioning the mold for the preparation of recipient blocks of claim 2 within a base mold;
(2) charging the base mold with a liquid material for the recipient block;
(3) solidifying the material and separating the base mold from the mold for the preparation of recipient blocks and the solidified material; and
(4) separating the mold for the preparation of recipient blocks from the solidified recipient block.

10. The method according to claim 9, wherein the liquid material for the recipient block includes paraffin.

11. The method according to claim 10, further including positioning a cassette on the material subsequent to charging the base mold with the liquid material for the recipient block.

12. The method according to claim 9, wherein the material is solidified in step (3) while being cooled.
